(19) United States
(12) Patent Application Publication
(10) Pub. No.: US 2026/0038169 A1
(43) Pub. Date: Feb. 5, 2026

(54) IMAGE-BASED DEVICE CUSTOMIZATION FOR MULTIPLE USERS

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/790,566

(22) Filed: Jul. 31, 2024

(51) Int. Cl. G06T 11/60; G06T 11/00

(52) U.S. Cl. CPC G06T 11/60; G06T 11/001; G06T 2210/16

(57) ABSTRACT

An electronic device captures an image of a group of multiple users. Two or more users of the group of multiple users that are included in the image are detected. For each of the two or more users, a customization for the user is automatically generated based at least in part on the appearance of the user in the image (e.g., apparel worn by the first user in the image). Additionally, for each of the two or more users, the electronic device associated with the user is automatically customized based at least in part on the customization generated for the user. The customization can be, for example, a color or pattern to be displayed on an electronic device associated with the first user.

### BACKGROUND

As technology has advanced electronic devices have become commonplace in our lives. For example, many people have cell phones and/or smart watches with them throughout the day. These electronic devices can be manually customized by the users, such as changing the information displayed on a lock screen, changing an image displayed as a background, and so forth.

### BRIEF DESCRIPTION OF THE DRAWINGS

Embodiments of image-based device customization for multiple users are described with reference to the following drawings. The same numbers are used throughout the drawings to reference like features and components:

FIG. 1 illustrates an example environment for image-based device customization for multiple users, as described herein.

FIG. 2 illustrates an example system for image-based device customization for multiple users, as described herein.

FIG. 3 illustrates an example of implementing the techniques discussed herein.

FIG. 4 illustrates an example implementing the techniques discussed herein.

FIG. 5 illustrates an example process for implementing the techniques discussed herein in accordance with one or more embodiments.

FIG. 6 illustrates an example process for implementing the techniques discussed herein in accordance with one or more embodiments.

FIG. 7 illustrates various components of an example electronic device that can implement embodiments of the techniques discussed herein.

### DETAILED DESCRIPTION

Image-based device customization for multiple users is discussed herein. Generally, an electronic device captures an image (e.g. a photo or a frame of video) of a group of multiple people (also referred to as users). Two or more users of the group of multiple users that are included in the image are detected. The two or more users can be less than all of the users in the image, such as only users in the image that are the user of the electronic device, that are included in a contacts list of the electronic device (e.g., a “favorites” list), and/or that are included in a collaborative space with the user of the electronic device.

A customization for a first user of the two or more users is automatically generated, the customization being based at least in part on the appearance of the first user in the image (e.g., apparel worn by the first user in the image). The customization can be, for example, a color or pattern to be displayed on an electronic device associated with the first user. In one example, an indication of the customization for the first user is communicated (e.g., transmitted or sent) to an electronic device associated with the first user, which can then apply the customization. In another example, the first user can be the user of the electronic device that captured the image, allowing the electronic device that captured the image to be customized based at least in part on the appearance of (e.g., apparel worn by) the user of the electronic device.

A customization for a second user of the two or more users is also automatically generated, the customization being based at least in part on the appearance of the second user in the image (e.g., apparel worn by the second user in the image). The customization can be, for example, a color or pattern to be displayed on an electronic device associated with the second user. An indication of the customization for the second user is communicated (e.g., transmitted or sent) to the electronic device associated with the second user. The electronic device associated with the second user can then apply the customization.

Accordingly, when an image that includes multiple users is captured, the image can be used as a basis for customization of different devices in different manners based on the appearance of the individual users in the image. For example, if the first user is wearing a green shirt and the second user is wearing a blue shirt, the electronic device associated with the first user can be automatically customized to display a green background to match the first user's green shirt whereas the electronic device associated with the second user can be automatically customized to display a blue background to match the second user's blue shirt.

Various aspects of implementations described herein can leverage artificial intelligence (AI) functionality (e.g., AI and/or machine learning algorithms, AI and/or machine learning models, etc.) to detect users in an image and/or to generate an indication of customization of an electronic device. As discussed herein, the terms “AI” and “machine learning” can be used to refer to machine-implemented intelligence for performing various tasks on data, such as data analysis, data classification, data modification, data generation, etc. For instance, AI functionality can be used for user image classification, such as to determine whether a user in an image is the user of the electronic device, is included in a contacts list of the electronic device (e.g., a “favorites” list), is included in a collaborative space with the user of the electronic device, and so forth. Further, AI functionality can be used to determine how to customize an electronic device based on the appearance of a user in the image. The described implementations can utilize different types of AI models, such as classifier models, generative models, prediction models, combinations thereof, etc.

Accordingly, the techniques discussed herein improve the operation of a computing device by allowing different electronic devices to be customized in different manners based on a single image.

While features and concepts of image-based device customization for multiple users can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

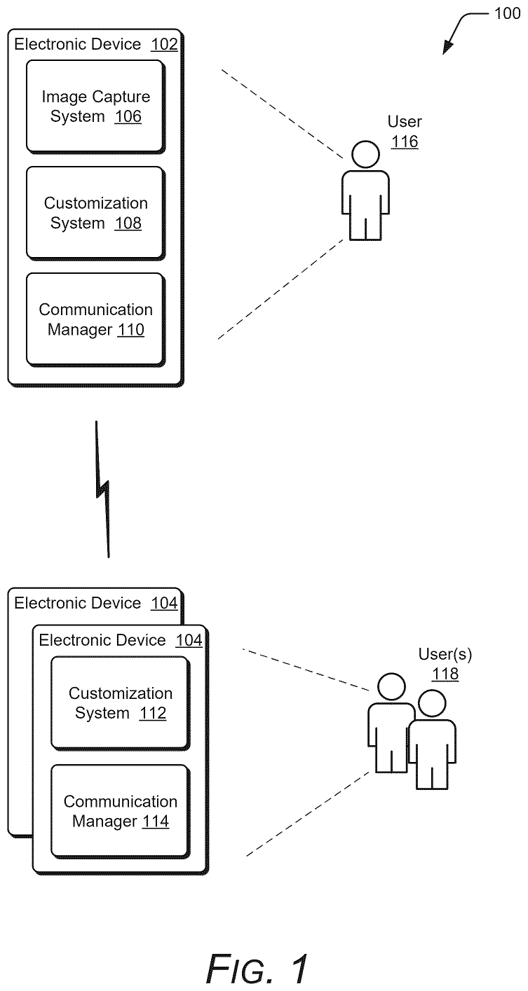

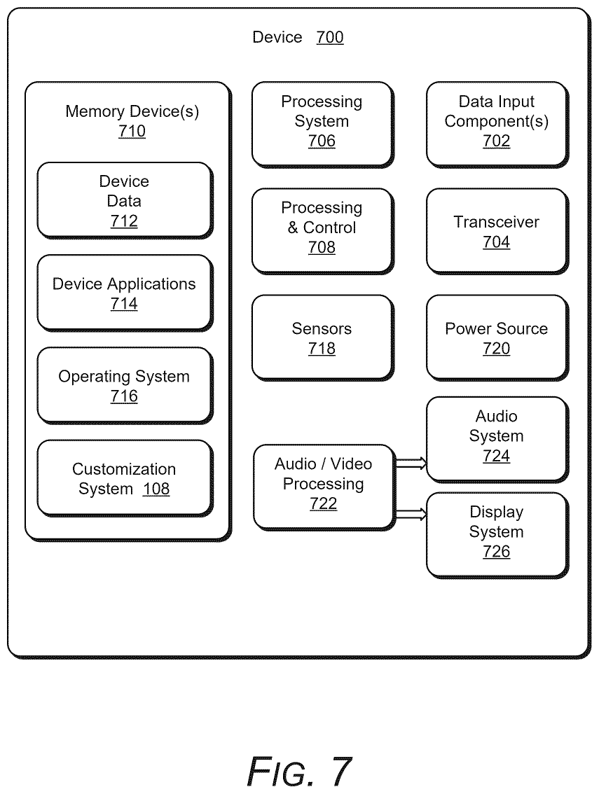

FIG. 1 illustrates an example environment 100 for image-based device customization for multiple users, as described herein. The example environment 100 includes an electronic device 102 and one or more electronic devices 104. In one or more implementations, the electronic devices 102 and 104 can be a smartphone, a mobile phone, a wearable phone (e.g., a smartwatch or a rollable or foldable phone), and/or any other type of wireless device. The electronic devices 102 and 104 can be implemented with various components, such as a processor system and memory, as well as any number and combination of different components as further described with reference to the example device shown in FIG. 7.

In one or more implementations, the electronic device 102 and the electronic devices 104 include various radios for wireless communication with other devices. For example, the electronic devices 102 and 104 may include a Bluetooth (BT) and/or Bluetooth Low Energy (BLE) transceiver and/or a near field communication (NFC) transceiver. Additionally or alternatively, the electronic devices 102 and 104 can also include a Wi-Fi radio, a global positioning system (GPS) radio, a radio for cellular communication (e.g., a third generation (3G) network, a fourth generation (4G) network, a fifth generation (5G) network, a sixth generation (6G) network), and/or any type of device communication interfaces. The electronic device 102 can communicate with the electronic devices 104 (and the electronic devices 104 can communicate with each other and/or with the electronic device 102) via the one or more intermediary devices (e.g., components of a cellular communication system, a Wi-Fi router) or directly (e.g., wired or wirelessly) with using any intermediary devices (e.g., BT or NFC).

The electronic device 102 also includes an image capture system 106, a customization system 108, and a communication manager 110. The electronic device 104 similarly includes a customization system 112 and a communication manager 114. Although not illustrated in the environment 100, one or more of the electronic devices 104 may also include an image capture system analogous to the image capture system 106.

The image capture system 106 captures images digitally using any of a variety of different technologies, such as a charge-coupled device (CCD) sensor, a complementary metal-oxide-semiconductor (CMOS) sensor, combinations thereof, and so forth. The image capture system 106 can include a single sensor and lens, or alternatively multiple sensors or multiple lenses. For example, the image capture system 106 may have at least one lens and sensor positioned to capture images from the front of the electronic device 102 (e.g., the same surface as a display is positioned on the electronic device 102), and at least one additional lens and sensor positioned to capture images from the back of the electronic device 102. The image capture system 106 can capture still images as well as video. The video can be, for example, a sequence of captured still images.

The electronic device 102 includes various functionality that enables the electronic device 102 to perform different aspects of image-based device customization for multiple users as discussed herein, including the customization system 108 and the communication manager 110. The customization system 108 receives one or more images captured by the image capture system 106. The image is captured, for example, in response to a user input from a user 116 of the electronic device 102. In one example, the user 116 is included in the image that is captured (e.g., the image may be a selfie). In another example, the user 116 is not included in the image that is captured.

The customization system 108 detects two or more users in the image. The two or more users detected by the customization system 108 can be all of the users in the image or less than all of the users in the image. For example, the customization system 108 may detect only users that are the user 116 of the electronic device 102 or that are included in a contacts list of the electronic device 102 (e.g., a “favorites” list).

The customization system 108 also generates a customization for each of the two or more users detected by the customization system 108. The customization for a user is based at least in part on the appearance of the user in the image. The appearance of the user refers to the way the user looks, and can include, for example, the apparel worn by the user (e.g., clothing, jewelry, shoes, accessories, glasses, bags), the color of the user's hair, the style of the user's hair (e.g., curly or straight), and so forth. Accordingly, different users can have different customizations due to their appearance in the image.

If the user 116 of the electronic device 102 is one of the two or more users detected by the customization system 108, then the customization system 108 customizes the electronic device 102 based at least in part on the determined customization for the user. This customization can be, for example, changing the wallpaper or background of a display of the electronic device 102.

For at least one user of the two or more users 118 of the electronic devices 104, the communication manager 110 communicates (e.g., transmits or sends) an indication of the customization for the user 118 to the electronic device 104 associated with that user 118. The electronic device 104 associated with a user refers to an electronic device 104 that is owned or used by the user. This association can be identified in various manners, such as based on an association between users devices associated with those users (e.g., maintained in a contact list or a collaborative space).

The communication manager 110 represents functionality (e.g., logic and hardware) for enabling the electronic device 102 to interconnect with other devices and/or one or more networks. The communication manager 110, for instance, enables wireless and/or wired connectivity of the electronic device 102. For example, the communication manager 110 represents one or more antennas for transmitting signaling to and/or receiving signaling from electronic devices 104. In one or more implementations, the communication manager 110 communicates with the electronic devices 104 via one or more intermediary devices (e.g., a cellular system, a Wi-Fi router). Additionally or alternatively, the communication manager 110 communicates with the electronic devices without using any intermediary devices (e.g., using Bluetooth).

The communication manager 114 at each electronic device 104 receives the indication of the customization for that electronic device 104, and the customization system 112 customizes the electronic device 104 based at least in part on the received customization indication. The communication manager 114 represents functionality (e.g., logic and hardware) for enabling the electronic device 104 to interconnect with other devices and/or one or more networks. The communication manager 114, for instance, enables wireless and/or wired connectivity of the electronic device 104. For example, the communication manager 114 represents one or more antennas for transmitting signaling to and/or receiving signaling from electronic device 102. In one or more implementations, the communication manager 114 communicates with the electronic device 102 (and optionally other electronic devices 104) via one or more intermediary devices (e.g., a cellular system, a Wi-Fi router). Additionally or alternatively, the communication manager 114 communicates with the electronic device 102 (and optionally other electronic devices 104) without using any intermediary devices (e.g., using Bluetooth).

Accordingly, for each of the two or more users detected in an image, the electronic device associated with the user is customized based at least in part on the appearance of that user (e.g., the apparel worn by that user).

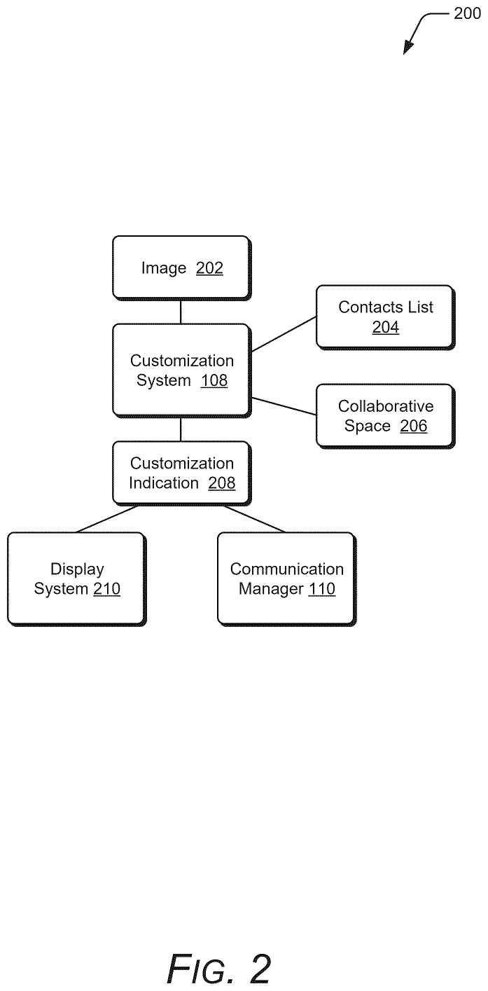

FIG. 2 illustrates an example system 200 for image-based device customization for multiple users, as described herein. The example system 200 includes the customization system 108 and the communication manager 110, discussed above with respect to FIG. 1.

An image 202 that includes multiple users is obtained by the system 200. The image 202 can be obtained in various manners, such as by being captured by an image capture system (e.g., the image capture system 106 of FIG. 2), being received from another device, and so forth.

The customization system 108 detects two or more users in the image 202. The two or more users detected by the customization system 108 can be all of the users in the image 202 or less than all of the users (e.g., a subset of the users) in the image 202. For example, the detected two or more users may be only users that are included in a collaborative space 206 with the user of the electronic device 102, or that are included in a contacts list of the electronic device 102.

The customization system 108 detects the two or more users in any of a variety of different manners. In one or more implementations, the customization system 108 detects the two or more users based on their presence in a contacts list of the users that are the user 116 of the electronic device 102 or that are included in a contacts list 204. The contacts list 204 can be stored locally with the customization system 108 (e.g., as part of the electronic device 102 of FIG. 1) or stored remotely (e.g., on a server or in the cloud). The contacts list 204 can be, for example, a “favorites” list, a list of close friends and/or family, a list of co-workers, and so forth. For each user in the contacts list 204, the contacts list 204 includes an indication of how to communicate with the user. This indication can be, for example, a phone number, an email address, and so forth.

Additionally or alternatively, the customization system 108 detects the two or more users based on their presence in a collaborative space 206. The collaborative space 206 is a space where users can link or associate themselves with other users. For example, a parent may include his or her children in the collaborative space 206. By way of another example, a person may include all of their family members (e.g., parents, siblings, nieces, nephews, etc.) in the collaborative space 206.

The collaborative space 206 can be a database, a server device, and/or any combination of devices that can store data, manipulate data, and/or provide for access of data for one or more devices, such as the electronic devices 102 and 104 of FIG. 1. In one or more implementations, the collaborative space 206 may be an example of a remote database (e.g., cloud or network-based database), a physical database, or the like. In some examples, the collaborative space 206 can be hosted at one of the electronic devices 102 or 104 as an application, module, and/or local database. Alternatively or in addition, the collaborative space 206 can be one or more of a web server, an application server, or a cloud server, among others. The collaborative space 206 can store identifiers of various users, such as users that have registered with the collaborative space 206, users that have been linked to or associated with the user of the electronic device 102 (e.g., the children and/or other family members of the user of the electronic device 102), and so forth. The collaborative space 206 can also store an indication of how to communicate with the other users, such as a phone number, an email address, and so forth.

In one or more implementations, the customization system 108 recognizes users in the image 202 that are included in the contacts list 204 or the collaborative space 206. This recognition can be performed in various manners. For example, for each user in the contacts list 204 or the collaborative space 206, one or more images of the user are maintained in the contacts list 204 or the collaborative space 206. The customization system 108 can use any of a variety of recognition systems (e.g., face recognition, iris recognition, etc.) to identify users that are in the image 202 and that are also listed or included in the contacts list 204 or the collaborative space 206.

The customization system 108 also generates a customization for each of the two or more users detected by the customization system 108. The customization for a user is based at least in part on the appearance of the user in the image 202. Accordingly, different users can have different customizations due to having different appearances in the image, such as different apparel being worn in the image, different hair colors or styles in the image, and so forth.

The customization for a user is an indication of how the electronic device of the user (e.g., electronic device 102 or one of the electronic devices 104) is to be customized based at least in part on the appearance of the user in the image 202. This customization can include visual customization, such as changing the colors or patterns displayed by a display system of the electronic device (e.g., the colors or patterns displayed as a background, wallpaper, lockscreen, for menus or borders, and so forth). This customization can also include non-visual customization, such as changes in type or style of audio played by the electronic device, changes in alerts, notifications, or ringtones played by the electronic device, and so forth.

The indication of how the electronic device of the user is to be customized can take various forms. For example, the indication can be an identification of a color to display, an identification of a pattern to display, an identification of an image to be displayed, and so forth.

In one or more implementations, the customization system 108 performs one or more image processing techniques to analyze the appearance of the user. The analysis can include determining a major color for the user (e.g., based on hair color or apparel worn by the user). The major color refers to the main or predominant color for the apparel. The analysis can include determining a formality level for the apparel. The customization can be created and/or selected based on the analysis of the appearance of the user. As an example, if the apparel worn by the user appears formal, then a conservative background and font style can be used for the electronic device. By way of another example, if the attire appears casual, then a more casual or festive appearance can be used for the electronic device. In another example, if the apparel worn by the user or the hair of the user is predominantly a particular color, e.g., purple, then the electronic device can be customized to display a similar green color for menus, borders, and/or other graphical elements. By way of another example, if the apparel worn by the user has a particular pattern (e.g., striped, paisley, or floral pattern), then the electronic device can be customized to display the same or a similar pattern as the background or wallpaper.

Different operations of the customization system 108 can be performed using AI functionality, such as one or more AI classifier models to detect two or more users in the image 202, and/or one or more AI generative models to determine how to customize the electronic device (e.g., generate the customization indication 208).

The customization system 108 generates a customization indication 208 indicating how the electronic device is to be customized. If the user that the customization is generated for is associated with the electronic device that captured the image (e.g., is associated with the electronic device 102), then the customization system 108 provides the customization indication 208 to a display system 210. Users can be identified as being associated with the electronic device that captured the image in various manners, such as by being included in the contacts list 204 or the collaborative space 206. The electronic device then customizes the electronic device as indicated by the customization indication 208.

However, if the user that the customization is generated for is associated with an electronic device other than the electronic device that captured the image (e.g., the user is associated with an electronic device 104), then the customization system 108 provides the customization indication 208 to the communication manager 110. The electronic device then customizes the electronic device as indicated by the customization indication 208.

The detection of two or more users in an image and generation of the customization can be performed on the electronic device that includes the customization system 108. Additionally or alternatively, the image 202 can be transferred to a remote server or device for analysis and the results can be returned to the customization system 108 on the electronic device.

In one or more implementations, the generated customization indications 208 are automatically communicated to the electronic devices 104. Additionally or alternatively, for each user of an electronic device 104 for which a customization is generated, the user of the system 200 (e.g., the user of the electronic device that captured the image) provides an input indicating whether to communicate the customization indication 208 to the electronic device 104 associated with that user. For example, the customization system 108 can generate a display prompting the user of the system 200 to select, for each user of an electronic device 104 for which a customization is generated, whether the customization indication 208 for that user is to be communicated to the electronic device 104. The customization indication 208 for a user is then communicated to the electronic device 104 associated with that user only if selected by the electronic device 104. This allows the user of the system 200 to determine which of the detected two or more users are to have their respective electronic devices 104 customized.

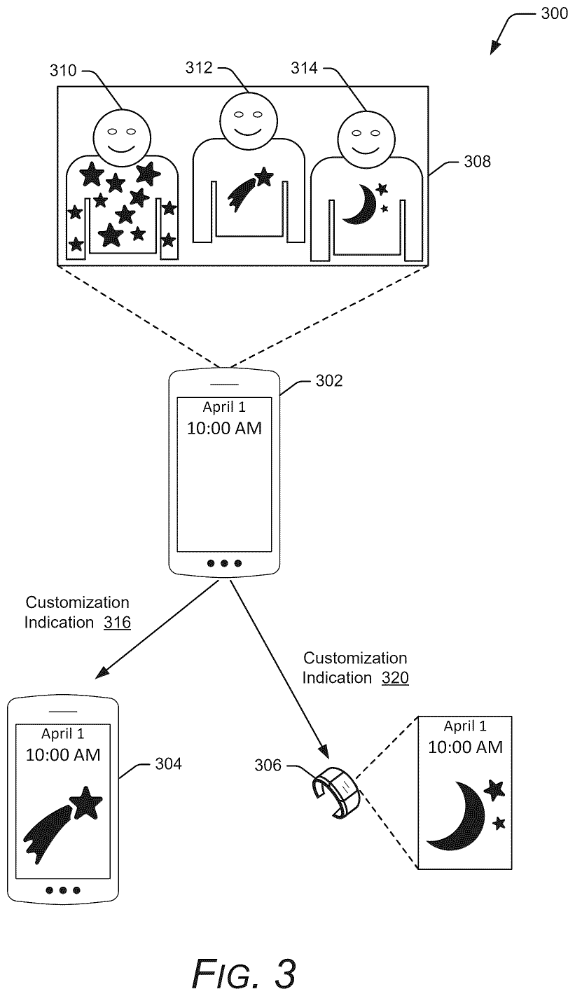

FIG. 3 illustrates an example 300 of implementing the techniques discussed herein. The example 300 illustrates an electronic device 302 (which can be an electronic device 102 of FIG. 1) and electronic devices 304 and 306 (each of which can be an electronic device 104 of FIG. 1). The electronic device 302 captures an image 308 that includes user 310 that is not associated with the user of the electronic device 302, user 312 that is associated with the user of the electronic device 302, and user 314 that is also associated with the user of the electronic device 302. The user of the electronic device 302 is not included in the image 308, so the display of the electronic device 302 is not customized based on the appearance of the user of the electronic device 302. Additionally, the user 310 is not associated with the user of the electronic device 302, so the display of the electronic device 302 is not customized based on the appearance of the user of the electronic device 302.

However, the user 312 and the user 314 are both associated with the user of the electronic device 302. Accordingly, the electronic device 302 communicates a customization indication 316 to the electronic device 304 associated with the user 312 and the display of the electronic device 304 is customized based on the appearance of the user 312 in the image 308. As illustrated the user 312 is wearing a shirt with a shooting star, so the electronic device 304 is customized to display a lock screen that includes a shooting star. Similarly, the electronic device 302 communicates a customization indication 320 to the electronic device 306 associated with the user 314 and the display of the electronic device 306 is customized based on the appearance of the user 314 in the image 308. As illustrated the user 314 is wearing a shirt with a moon and stars, so the electronic device 306 is customized to display a lock screen that includes a moon and stars.

Although the example 300 illustrates lock screens being customized based at least in part on the appearance of the users of the devices 304 and 306, it is to be appreciated that the devices 304 and 306 can be customized in other manners based at least in part on the appearance of the users of the devices 304 and 306. For example, backgrounds (e.g., wallpaper) displayed by the device 304 and 306 after being unlocked can be customized (e.g., to include a shooting star, or moon and stars), menus or borders can be customized (e.g., to be the color of the shooting star, or moon and stars), and so forth.

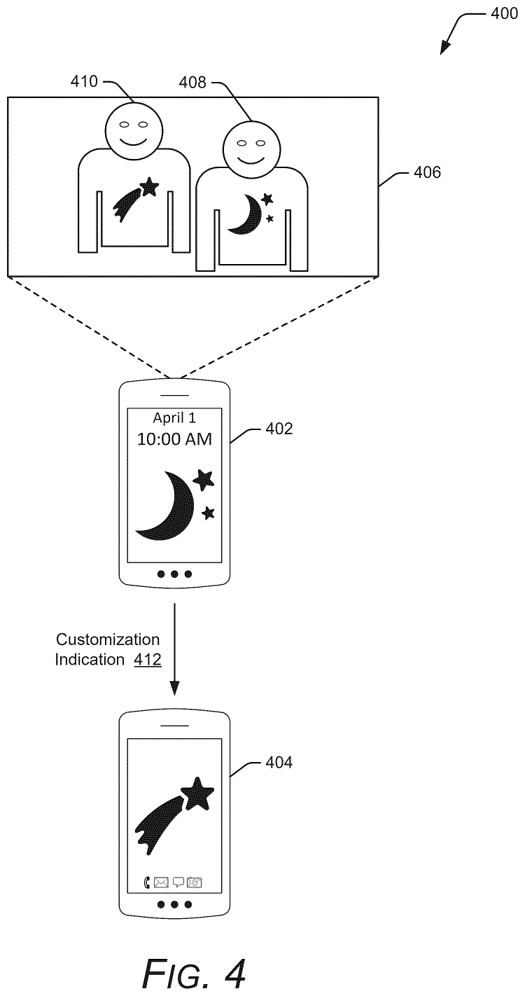

FIG. 4 illustrates an example 400 implementing the techniques discussed herein. The example 400 illustrates an electronic device 402 (which can be an electronic device 102 of FIG. 1) and electronic device 404 (which can be an electronic device 104 of FIG. 1). The electronic device 402 captures an image 406 that includes user 408 that is the user of the electronic device 402, and user 410 that is associated with the user of the electronic device 402. The user of the electronic device 402 is included in the image 406, so the display of the electronic device 402 is customized based on the appearance of the user 408 in the image 406. As illustrated the user 408 is wearing a shirt with a moon and stars, so the electronic device 402 is customized to display a lock screen that includes a moon and stars.

Since the users 410 is associated with the user of the electronic device 402, the electronic device 402 communicates a customization indication 412 to the electronic device 404 associated with the user 410 and the electronic device 404 is customized based on the appearance of the user 410 in the image 406. As illustrated the user 410 is wearing a shirt with a shooting star, so the electronic device 402 is customized to display wallpaper (after the electronic device 404 is unlocked) that includes a shooting star.

Although the example 400 illustrates lock screens or wallpaper being customized based at least in part on the appearance of the users of the devices 402 and 404, it is to be appreciated that the devices 402 and 404 can be customized in other manners based at least in part on the appearance of the users of the devices 402 and 404. For example, the lockscreen of device 404 can be customized (e.g., to include a shooting star), a background (e.g., wallpaper) displayed by the device 402 after being unlocked can be customized (e.g., to a moon and stars), menus or borders displayed by the devices 402 and 404 can be customized (e.g., to be the color of the shooting star, or moon and stars), and so forth.

Accordingly, the techniques discussed herein allow devices to be customized to based at least in part on the appearances of theirs users in an image. However, not all users in the image need have their devices customized. For example, a user may capture an image that includes family members and friends, and have the devices used by the family members in the image (e.g., as indicated by the contacts list 204 or collaborative space 206) customized but not the devices used by the friends in the image. By way of another example, a user may capture an image that includes only family members, and have the devices used by some family members (e.g., siblings and/or parents, as indicated by the contacts list 204 or collaborative space 206) customized but not the devices used by other family members in the image.

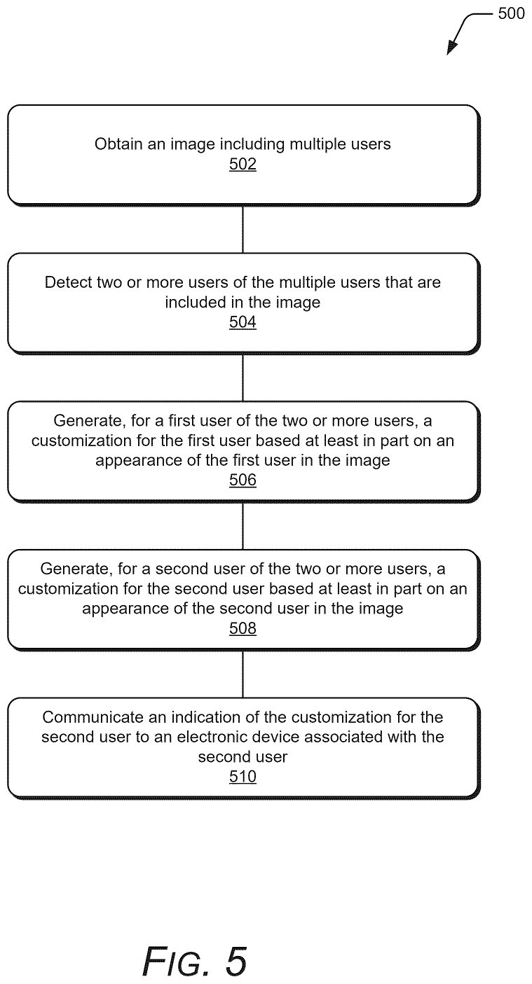

FIG. 5 illustrates an example process 500 for implementing the techniques discussed herein in accordance with one or more embodiments. Process 500 is carried out at least in part by a customization system, such as customization system 108 of FIG. 1 or FIG. 2, and can be implemented in software, firmware, hardware, or combinations thereof. Process 600 is shown as a set of acts and is not limited to the order shown for performing the operations of the various acts.

In process 500, an image including multiple users is obtained (act 502). The image can be obtained in various manners, such as by being captured by a device implementing the process 500 or received from another device.

Two or more users of the multiple users that are included in the image are detected (act 504). These two or more users can be users that are associated with the electronic device that obtained the image, such as included in a contacts list of the user of the electronic device that obtained the image, or included in a same collaborative space as the user of the electronic device that obtained the image.

A customization for a first user of the two or more users is generated based at least in part on an appearance of the first user in the image (act 506). The appearance of the first user refers to the way the first user looks, and can include, for example, the apparel worn by the first user (e.g., clothing, jewelry, shoes, accessories, glasses, bags), the color of the user's hair, the style of the user's hair (e.g., curly or straight), and so forth.

A customization for a second user of the two or more users is generated based at least in part on an appearance of the second user in the image (act 508). The appearance of the second user refers to the way the second user looks, and can include, for example, the apparel worn by the second user (e.g., clothing, jewelry, shoes, accessories, glasses, bags), the color of the user's hair, the style of the user's hair (e.g., curly or straight), and so forth.

An indication of the customization for the second user is communicated to an electronic device associated with the second user (act 510). This allows the electronic device associated with the second user to be automatically customized based at least in part on the customization for the second user.

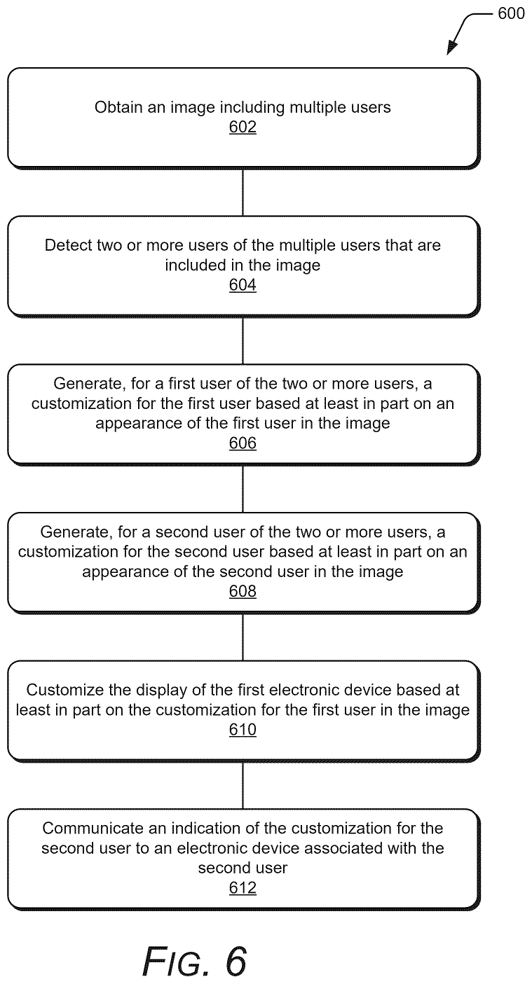

FIG. 6 illustrates an example process 600 for implementing the techniques discussed herein in accordance with one or more embodiments. Process 600 is carried out at least in part by a customization system, such as customization system 108 of FIG. 1 or FIG. 2, and can be implemented in software, firmware, hardware, or combinations thereof. Process 600 is similar to process 500 of FIG. 5, but includes an element of customizing the display of the first electronic device based at least in part on the customization for the first user in the image. Process 600 is shown as a set of acts and is not limited to the order shown for performing the operations of the various acts.

In process 600, an image including multiple users is obtained (act 602). The image can be obtained in various manners, such as by being captured by a device implementing the process 600 or received from another device.

Two or more users of the multiple users that are included in the image are detected (act 604). These two or more users can be users that are associated with the electronic device that obtained the image, such as included in a contacts list of the user of the electronic device that obtained the image, or included in a same collaborative space as the user of the electronic device that obtained the image.

A customization for a first user of the two or more users is generated based at least in part on an appearance of the first user in the image (act 606). The appearance of the first user refers to the way the first user looks, and can include, for example, the apparel worn by the first user (e.g., clothing, jewelry, shoes, accessories, glasses, bags), the color of the user's hair, the style of the user's hair (e.g., curly or straight), and so forth.

A customization for a second user of the two or more users is generated based at least in part on an appearance of the second user in the image (act 608). The appearance of the second user refers to the way the second user looks, and can include, for example, the apparel worn by the second user (e.g., clothing, jewelry, shoes, accessories, glasses, bags), the color of the user's hair, the style of the user's hair (e.g., curly or straight), and so forth.

The display of the first electronic device is customized based at least in part on the customization for the first user in the image (act 610). This customization can include visual customization, such as changing the colors or patterns displayed by a display system of the electronic device (e.g., the colors or patterns displayed as a background, wallpaper, lockscreen, for menus or borders, and so forth). This customization can also include non-visual customization, such as changes in type or style of audio played by the electronic device, changes in alerts, notifications, or ringtones played by the electronic device, and so forth.

An indication of the customization for the second user is communicated to an electronic device associated with the second user (act 612). This allows the electronic device associated with the second user to be automatically customized based at least in part on the customization for the second user.

FIG. 7 illustrates various components of an example electronic device that can implement embodiments of the techniques discussed herein. The electronic device 700 can be implemented as any of the devices described with reference to the previous FIG.s, such as any type of client device, mobile phone, tablet, computing, communication, entertainment, gaming, media playback, or other type of electronic device. In one or more embodiments the electronic device 700 includes the customization system 108, described above.

The electronic device 700 includes one or more data input components 702 via which any type of data, media content, or inputs can be received such as user-selectable inputs, messages, music, television content, recorded video content, and any other type of text, audio, video, or image data received from any content or data source. The data input components 702 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 702 may also include various other input components such as microphones, touch sensors, touchscreens, keyboards, and so forth.

The device 700 includes communication transceivers 704 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 700 includes a processing system 706 of one or more processors (e.g., any of microprocessors, controllers, and the like) or a processor and memory system implemented as a system-on-chip (SoC) that processes computer-executable instructions. The processing system 706 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 708. The device 700 may further include any type of a system bus or other data and command transfer system that couples the various components within the device. A system bus can include any one or combination of different bus structures and architectures, as well as control and data lines.

The device 700 also includes computer-readable storage memory devices 710 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 710 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory device 710 provides data storage mechanisms to store the device data 712, other types of information or data, and various device applications 714 (e.g., software applications). For example, an operating system 716 can be maintained as software instructions with a memory device and executed by the processing system 706 to cause the processing system 706 to perform various acts. The device applications 714 may also include a device manager, such as any form of a control application, software application, signal-processing and control module, code that is native to a particular device, a hardware abstraction layer for a particular device, and so on.

The device 700 can also include one or more device sensors 718, such as any one or more of an ambient light sensor, a proximity sensor, a touch sensor, an infrared (IR) sensor, accelerometer, gyroscope, thermal sensor, audio sensor (e.g., microphone), and the like. The device 700 can also include one or more power sources 720, such as when the device 700 is implemented as a mobile device. The power sources 720 may include a charging or power system, and can be implemented as a flexible strip battery, a rechargeable battery, a charged super-capacitor, or any other type of active or passive power source.

The device 700 additionally includes an audio or video processing system 722 that generates one or both of audio data for an audio system 724 and display data for a display system 726. In accordance with some embodiments, the audio/video processing system 722 is configured to receive call audio data from the transceiver 704 and communicate the call audio data to the audio system 724 for playback at the device 700. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for image-based device customization for multiple users have been described in language specific to features or methods, the subject of the appended claims is not necessarily limited to the specific features or methods described. Rather, the specific features and methods are disclosed as example implementations of techniques for implementing image-based device customization for multiple users. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first electronic device, including: at least one memory; and at least one processor coupled with the at least one memory and configured to cause the electronic device to: obtain an image including multiple users; detect two or more users of the multiple users that are included in the image; generate, for a first user of the two or more users, a customization for the first user based at least in part on an appearance of the first user in the image; generate, for a second user of the two or more users, a customization for the second user based at least in part on an appearance of the second user in the image; communicate an indication of the customization for the second user to a second electronic device associated with the second user.

In some aspects, the techniques described herein relate to a first electronic device, wherein the customization for the first user in the image is different than the customization for the second user in the image.

In some aspects, the techniques described herein relate to a first electronic device, wherein the appearance of the first user in the image includes apparel worn by the first user in the image, and the appearance of the second user in the image includes apparel worn by the second user in the image.

In some aspects, the techniques described herein relate to a first electronic device, wherein first electronic device further includes a display, the first user in the image is a user of the first electronic device, and the at least one processor is further configured to cause the first electronic device to customize the display of the first electronic device based at least in part on the customization for the first user in the image.

In some aspects, the techniques described herein relate to a first electronic device, wherein the at least one processor is further configured to cause the first electronic device to: identify a color within apparel worn by the first user in the image; and render a background image on the display that includes a similar color to the identified color within the apparel.

In some aspects, the techniques described herein relate to a first electronic device, wherein the first electronic device further includes an image capture system, and the at least one processor is further configured to cause the first electronic device to obtain the image by capturing the image with the image capture system.

In some aspects, the techniques described herein relate to a first electronic device, wherein the at least one processor is further configured to cause the first electronic device to communicate an indication of the customization for the first user to an electronic device associated with the first user.

In some aspects, the techniques described herein relate to a first electronic device, wherein the two or more users are less than all of the multiple users included in the image.

In some aspects, the techniques described herein relate to a first electronic device, wherein the at least one processor is further configured to cause the first electronic device to display a prompt for a user of the electronic device to select whether to have the indication of the customization for the second user communicated to the second electronic device associated with the second user.

In some aspects, the techniques described herein relate to a first electronic device, wherein the two or more users of the multiple users are associated with a user of the first electronic device.

In some aspects, the techniques described herein relate to a first electronic device, wherein the two or more users are associated with the user of the first electronic device by being included in a contacts list of the user of the first electronic device or being part of a same collaborative space as the user of the first electronic device.

In some aspects, the techniques described herein relate to a method, including: obtaining an image including multiple users; detecting two or more users of the multiple users that are included in the image; generating, for a first user of the two or more users, a customization for the first user based at least in part on an appearance of the first user in the image; generating, for a second user of the two or more users, a customization for the second user based at least in part on an appearance of the second user in the image; and communicating an indication of the customization for the second user to an electronic device associated with the second user.

In some aspects, the techniques described herein relate to a method, further including communicating an indication of the customization for the first user to an electronic device associated with the first user.

In some aspects, the techniques described herein relate to a method, wherein the two or more users are less than all of the multiple users included in the image.

In some aspects, the techniques described herein relate to a method, further including displaying a prompt for a user of the electronic device to select whether to have the indication of the customization for the second user communicated to the electronic device associated with the second user.

In some aspects, the techniques described herein relate to a method, wherein the two or more users of the multiple users are associated with a user of the first electronic device.

In some aspects, the techniques described herein relate to a system, including: at least one memory; and at least one processor coupled with the at least one memory and configured to cause the system to: capture an image including multiple users; detect two or more users of the multiple users that are included in the image; generate, for a first user of the two or more users, a customization for the first user based at least in part on an appearance of the first user in the image; generate, for a second user of the two or more users, a customization for the second user based at least in part on an appearance of the second user in the image; communicate an indication of the customization for the second user to an electronic device associated with the second user.

In some aspects, the techniques described herein relate to a system, wherein the appearance of the first user in the image includes apparel worn by the first user in the image, and the appearance of the second user in the image includes apparel worn by the second user in the image.

In some aspects, the techniques described herein relate to a system, wherein the first user in the image is a user of the system, and the at least one processor is further configured to cause the system to customize a display of an electronic device including the system based at least in part on the customization for the first user in the image.

In some aspects, the techniques described herein relate to a system, wherein the at least one processor is further configured to cause the system to: identify a color within apparel worn by the first user in the image; and render a background image on the display that includes a similar color to the identified color within the apparel.

What is claimed is:

1. A first electronic device, comprising:
at least one memory; and
at least one processor coupled with the at least one memory and configured to cause the electronic device to:
obtain an image including multiple users;
detect two or more users of the multiple users that are included in the image;
generate, for a first user of the two or more users, a customization for the first user based at least in part on an appearance of the first user in the image;
generate, for a second user of the two or more users, a customization for the second user based at least in part on an appearance of the second user in the image;
communicate an indication of the customization for the second user to a second electronic device associated with the second user.

2. The first electronic device of claim 1, wherein the customization for the first user in the image is different than the customization for the second user in the image.

3. The first electronic device of claim 1, wherein the appearance of the first user in the image includes apparel worn by the first user in the image, and the appearance of the second user in the image includes apparel worn by the second user in the image.

4. The first electronic device of claim 1, wherein first electronic device further comprises a display, the first user in the image is a user of the first electronic device, and the at least one processor is further configured to cause the first electronic device to customize the display of the first electronic device based at least in part on the customization for the first user in the image.

5. The first electronic device of claim 4, wherein the at least one processor is further configured to cause the first electronic device to:
identify a color within apparel worn by the first user in the image; and
render a background image on the display that includes a similar color to the identified color within the apparel.

6. The first electronic device of claim 1, wherein the first electronic device further comprises an image capture system, and the at least one processor is further configured to cause the first electronic device to obtain the image by capturing the image with the image capture system.

7. The first electronic device of claim 1, wherein the at least one processor is further configured to cause the first electronic device to communicate an indication of the customization for the first user to an electronic device associated with the first user.

8. The first electronic device of claim 1, wherein the two or more users are less than all of the multiple users included in the image.

9. The first electronic device of claim 1, wherein the at least one processor is further configured to cause the first electronic device to display a prompt for a user of the electronic device to select whether to have the indication of the customization for the second user communicated to the second electronic device associated with the second user.

10. The first electronic device of claim 1, wherein the two or more users of the multiple users are associated with a user of the first electronic device.

11. The first electronic device of claim 10, wherein the two or more users are associated with the user of the first electronic device by being included in a contacts list of the user of the first electronic device or being part of a same collaborative space as the user of the first electronic device.

12. A method, comprising:
obtaining an image including multiple users;
detecting two or more users of the multiple users that are included in the image;
generating, for a first user of the two or more users, a customization for the first user based at least in part on an appearance of the first user in the image;
generating, for a second user of the two or more users, a customization for the second user based at least in part on an appearance of the second user in the image; and
communicating an indication of the customization for the second user to an electronic device associated with the second user.

13. The method of claim 12, further comprising communicating an indication of the customization for the first user to an electronic device associated with the first user.

14. The method of claim 12, wherein the two or more users are less than all of the multiple users included in the image.

15. The method of claim 12, further comprising displaying a prompt for a user of the electronic device to select whether to have the indication of the customization for the second user communicated to the electronic device associated with the second user.

16. The method of claim 12, wherein the two or more users of the multiple users are associated with a user of the first electronic device.

17. A system, comprising:
at least one memory; and
at least one processor coupled with the at least one memory and configured to cause the system to:
capture an image including multiple users;
detect two or more users of the multiple users that are included in the image;
generate, for a first user of the two or more users, a customization for the first user based at least in part on an appearance of the first user in the image;
generate, for a second user of the two or more users, a customization for the second user based at least in part on an appearance of the second user in the image;
communicate an indication of the customization for the second user to an electronic device associated with the second user.

18. The system of claim 17, wherein the appearance of the first user in the image includes apparel worn by the first user in the image, and the appearance of the second user in the image includes apparel worn by the second user in the image.

19. The system of claim 17, wherein the first user in the image is a user of the system, and the at least one processor is further configured to cause the system to customize a display of an electronic device including the system based at least in part on the customization for the first user in the image.

20. The system of claim 19, wherein the at least one processor is further configured to cause the system to:
identify a color within apparel worn by the first user in the image; and
render a background image on the display that includes a similar color to the identified color within the apparel.
